(19) United States
(12) Patent Application Publication
(10) Pub. No.: US 2003/0162679 A1
(43) Pub. Date: Aug. 28, 2003

(54) Hydrophobically modified polymer formulations

(76) Inventors: Klein A. Rodrigues, Signal Mountain, TN (US); Martin Crossman, Hixson, TN (US)

Correspondence Address: Thomas F. Roland, NATIONAL STARCH AND CHEMICAL COMPANY, P.O. Box 6500, Bridgewater, NJ, 08807-0500, US

(21) Appl. No.: 10/047,957

(22) Filed: Jan. 15, 2002

(51) Int. Cl. C11D 17/00

(52) U.S. Cl. 510/296; 510/475; 510/220

(57) ABSTRACT

A single-dose detergent formulation having a hydrophobically modified polymer and useful for either laundry or auto dishwashing applications is presented. The polymer consists of a hydrophilic backbone to which a hydrophobic moiety has been added by means of at least one hydrophobic monomer, chain transfer agent, or surfactant. The hydrophobically modified polymer is soluble in non-aqueous solvents, and useful in sachets or pouches for single-dose applications. The polymer also inhibits the corrosion of aluminum, and is therefore useful in applications such as cleaning and de-icing, or in a metal-working fluid.

### FIELD OF THE INVENTION

This invention relates to formulations containing hydrophobically modified polymers. The polymers are useful in increasing the dissolution rates of surfactants into aqueous systems, especially from single-dose tablets, pouches, and sachets Furthermore, the polymers are useful in suspending hydrophobic soils in autodish and hard surface cleaning applications. The hydrophobically modified polymers also act as corrosion inhibitors for aluminum in a variety of applications.

### BACKGROUND OF THE INVENTION

Hydrophobically modified polymers have been shown to have good soil release properties. Formulations containing these polymers are useful in cleaning applications, especially for fabrics. U.S. Pat. No. 5,723,434 describes the use of hydrophobically modified polymers in laundry detergents.

U.S. Pat. No. 5,650,473 discloses the synthesis and use of hydrophobic styrene copolymers. The hydrophobic copolymers were found to be particularly useful in laundry applications, as well as useful in other cleaning compositions, including for automatic and manual dishwasher detergents.

Hydrophobically modified copolymers are useful in textile treating processes, as disclosed in U.S. patent application No. 09/441,714.

Surprisingly it has been found that in addition to excellent soil release properties, hydrophobically modified copolymers are excellent dissolution aids. This property allows these polymers to quickly disperse active ingredients into laundry and auto-dishwashing applications, especially when the active ingredients are in the form of tablets or sachets. Tablets and sachets offer the advantage of providing a pre-measured single dose of a detergent, without the mess associated with measuring from a larger quantity.

Surfactants in a tablet formulation take a relatively long time to dissolve because the ingredients in the formulation are compressed together in a compact form. Thus a tablet that has sufficient strength to withstand the wear and tear of storage and use, does not necessarily dissolve in an acceptable manner. The polymers of this invention interact with the surfactant phases and prevent the formation of gel, thus increasing the solubility rate of the tablets.

Sachets are single dose formulations containing a non-aqueous formulation enclosed in a pouch that is typically made of poly vinyl alcohol. The formulation needs to be non-aqueous so that the pouch skin or cover does not dissolve during storage, but only on introduction into the wash water. Typically a non-aqueous solvent such as propylene glycol is used in this type of system. Polymers typically used in detergents such as polyacrylic acids and acrylate-maleate copolymers are not soluble in non-aqueous solvents. The hydrophobically modified polymers of this invention are soluble in the non-aqueous solvents used in sachet formulations. Furthermore, the polymers help the surfactants dissolve in the wash liquor.

The hydrophobic portions of these polymers are effective 1n suspending hydrophobic soils like foods in autodish applications. Furthermore, they are effective at suspending and removing hydrophobic soils such as soap scum in hard surface cleaning applications. The polymers of the invention are also efficient at minimizing the corrosion rates of aluminum in a number of applications, ranging from dishwashing to aircraft cleaning formulations to metal working fluids.

### SUMMARY OF THE INVENTION

The present invention is directed to a discrete or single-dose detergent formulation comprising a hydrophobically modified polymer comprising:

a) a hydrophilic backbone prepared from at least one monomer selected from the group consisting of:

1) an ethylenically unsaturated hydrophilic monomer selected from the group consisting of unsaturated C₁-C₆ acid, amide, ether, alcohol, aldehyde, anhydride, ketone and ester;

2) polymerizable hydrophilic cyclic monomer;

3) non-ethylenically unsaturated polymerizable hydrophilic monomer which is selected from the group consisting of glycerol and other polyhydric alcohols;

4) and combinations thereof,

wherein said hydrophilic backbone is optionally substituted with one or more amino, amine, amide, sulfonate, sulfate, phosphonate, phosphate, hydroxy, carboxyl or oxide groups; and

b) at least one hydrophobic moiety prepared from at least one hydrophobic monomer, chain transfer agent, or surfactant; said hydrophobic monomer is selected from the group consisting of a siloxane, saturated or unsaturated alkyl, and alkoxy group, aryl and aryl-alkyl group, alkyl sulfonate, aryl sulfonate, and combinations thereof; said chain transfer agent has 1 to 24 carbon atoms and is selected from the group consisting of a mercaptan, amine, alcohol, alpha olefin sulphonate, and combinations thereof; and said surfactant is an alcohol ethoxylate or an alkyl phenol ethoxylate or alkyl benzene sulfonate.

wherein said formulation is formed into pre-measured single dose portions.

The invention is also directed to a formulation containing a non-aqueous solution comprising the hydrophobically modified copolymer described above. The polymer being dissolved in a solvent such as ethylene glycol, propylene glycol, or polypropylene glycol.

The invention is further directed to a method for treating aluminum comprising contacting at least one surface of an aluminum object with a solution comprising a the hydrophobically modified copolymer described above.

### DESCRIPTION OF THE INVENTION

The invention relates to formulations containing hydrophobically modified polymers, and in particular formulations for single-dose applications or formulations requiring aluminum corrosion inhibition.

The hydrophobically modified polymer has a hydrophilic backbone and at least one hydrophobic moiety. The hydrophilic backbone may be linear or branched and is prepared from at least one ethylenically unsaturated hydrophilic monomer selected from unsaturated acids preferably C₁-C₆ acids, amides, ethers, alcohols, aldehydes, anhydrides, ketones and esters; polymerizable hydrophilic cyclic monomers; and non-ethylenically unsaturated polymerizable hydrophilic monomers selected from glycerol and other polyhydric alcohols. Combinations of hydrophilic monomers may also be used. Preferably the hydrophilic monomers are sufficiently water soluble to form at least a 1% by weight solution in water.

Preferably the ethylenically unsaturated hydrophilic monomers are mono-unsaturated. Examples of ethylenically unsaturated hydrophilic monomers are, for example, acrylic acid, methacrylic acid, ethacrylic acid, alpha-chloro-acrylic acid, alpha-cyano acrylic acid, beta methyl-acrylic acid (crotonic acid), alpha-phenyl acrylic acid, beta-acryloxy propionic acid, sorbic acid, alpha-chloro sorbic acid, angelic acid, cinnamic acid, p-chloro cinnamic acid, beta-styryl acrylic acid (1-carboxy-4-phenyl butadiene-1,3), itaconic acid, maleic acid, citraconic acid, mesaconic acid, glutaconic acid, aconitic acid, fumaric acid, tricarboxy ethylene, 2-acryloxypropionic acid, 2-acrylamido-2-methyl propane sulfonic acid, vinyl sulfonic acid, vinyl phosphonic acid, 2-hydroxy ethyl acrylate, tri methyl propane triacrylate, sodium methallyl sulfonate, sulfonated styrene, allyloxybenzenesulfonic acid, dimethylacrylamide, dimethylaminopropylmethacrylate, diethylaminopropylmethacrylate, vinyl formamide, vinyl acetamide, polyethylene glycol esters of acrylic acid and methacrylic acid and itaconic acid, vinyl pyrrolidone, vinyl imidazole, maleic acid, and maleic anhydride. Combinations of ethylenically unsaturated hydrophilic monomers may also be used. Preferably, the ethylenically unsaturated hydrophilic monomer is selected from acrylic acid, maleic acid, itaconic acid, and mixtures thereof.

The polymerizable hydrophilic cyclic monomers may have cyclic units that are either unsaturated or contain groups capable of forming inter-monomer linkages. In linking such cyclic monomers, the ring-structure of the monomers may either be kept intact, or the ring structure may be disrupted to form the backbone structure. Examples of cyclic units are sugar units such as saccharides and glucosides, cellulose ethers, and alkoxy units such as ethylene oxide and propylene oxide.

The hydrophilic backbone of the hydrophobically modified polymer may optionally be substituted with one or more amino, amine, amide, sulfonate, sulfate, phosphonate, phosphate, hydroxy, carboxyl or oxide groups. The hydrophilic backbone of the polymer may also contain small amounts of relatively hydrophobic units, for example, units derived from polymers having a solubility of less than 1 g/l in water, provided that the overall solubility of the polymer in water at ambient temperature and at a pH of 3.0 to 12.5 is more than 1 g/l, more preferably more than 5 g/l, and most preferably more than 10 g/l. Examples of relatively water insoluble monomers are vinyl acetate, methyl methacrylate, ethyl acrylate, ethylene, propylene, hydroxy propyl acetate, styrene, octyl methacrylate, lauryl methacrylate, stearyl methacrylate, behenyl methacrylate.

The hydrophobic moieties are linked to the hydrophilic backbone by any possible chemical link, although the following types of linkages are preferred:

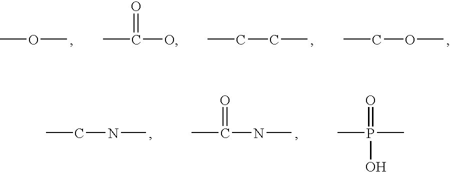

The hydrophobic moiety may also be incorporated onto the hydrophilic backbone through the use of surfactant molecules. The hydrophilic acid monomers may be grafted onto a surfactant backbone. Alternatively, a surfactant may be attached to a polymerizable unit, such as, for example, an ester of methacrylic acid and a C₁₂₋₂₂, preferably C₁₆₋₁₈ alkoxypoly(ethyleneoxy) ethanol having about twenty ethoxy units. This polymerizable unit may then be incorporated into the polymer.

Preferably the hydrophobic moieties are part of a monomer unit which is incorporated in the polymer by copolymerising hydrophobic monomers and the hydrophilic monomers making up the backbone of the polymer. The hydrophobic moieties preferably include those which when isolated from their linkage are relatively water insoluble, i.e. preferably less than 1 g/l more preferred less than 0.5 g/l, most preferred less than 0.1 g/l of the hydrophobic monomers, will dissolve in water at ambient temperature and a pH of 3 to 12.5.

Preferably the hydrophobic moieties are selected from siloxanes, aryl sulfonate, saturated and unsaturated alkyl moieties optionally having functional end groups, wherein the alkyl moieties have from 5 to 24 carbon atoms, preferably from 6 to 18, most preferred from 8 to 16 carbon atoms, and are optionally bonded to the hydrophilic backbone by means of an alkoxylene or polyalkoxylene linkage, for example a polyethoxy, polypropoxy or butyloxy (or mixtures of same) linkage having from 1 to 50 alkoxylene groups. Alternatively the hydrophobic moiety may be composed of relatively hydrophobic alkoxy groups, for example butylene oxide and/or propylene oxide, in the absence of alkyl or alkenyl groups.

Examples of hydrophobic monomers include styrene, α-methyl styrene, 2-ethylhexyl acrylate, octylacrylate, lauryl acrylate, stearyl acrylate, behenyl acrylate, 2-ethylhexyl methacrylate, octylmethacrylate, lauryl methacrylate, stearyl methacrylate, behenyl methacrylate, 2-ethylhexyl acrylamide, octylacrylamide, lauryl acrylamide, stearyl acrylamide, behenyl acrylamide, propyl acrylate, butyl acrylate, pentyl acrylate, hexyl acrylate, 1-vinyl naphthalene, 2-vinyl naphthalene, 3-methyl styrene, 4-propyl styrene, t-butyl styrene, 4-cyclohexyl styrene, 4-dodecyl styrene, 2-ethyl-4-benzyl styrene, and 4-(phenylbutyl) styrene. Combinations of hydrophobic monomers may also be used.

Alternatively, or in addition to, the hydrophobic moiety may be introduced into the polymer in the form of a chain transfer agent. The chain transfer agent has from 1 to 24 carbon atoms, preferably 1 to 14 carbon atoms, more preferably 3 to 12 carbon atoms. The chain transfer agent is selected from mercaptans or thiols, amines, alcohols, or alpha olefin sulphonates. A combination of chain transfer agents can also be used. Mercaptans useful in this invention are organic mercaptans which contain at least one—SH or thiol group and which are classified as aliphatic, cycloaliphatic, or aromatic mercaptans. The mercaptans can contain other substituents in addition to hydrocarbon groups, such substituents including carboxylic acid groups, hydroxyl groups, ether groups, ester groups, sulfide groups, amine groups and amide groups. Suitable mercaptans are, for example, methyl mercaptan, ethyl mercaptan, butyl mercaptan, mercaptoethanol, mercaptopropanol, mercaptobutanol, mercaptoacetic acid, mercaptopropionic acid, thiomalic acid, benzyl mercaptan, phenyl mercaptan, cyclohexyl mercaptan, 1-thioglycerol, 2.2′-dimercaptodiethyl ether, 2,2′-dimercaptodipropyl ether, 2,2′-dimercaptodiisopropyl ether, 3,3′-dimercaptodipropyl ether, 2,2′-dimercaptodiethyl sulfide, 3,3′-dimercaptodipropyl sulfide, bis(beta-mercaptoethoxy) methane, bis(beta-mercaptoethylthio)methane ethanedithio-1,2, propanedithiol-1,2, butanedithiol-1,4,3,4-dimercaptobutanol-1, trimethylolethane tri(3-mercaptopropionate), pentaerythritol tetra(3-mercapto-propionate), trimethylolpropane trithioglycolate, pentaerythritol tetrathio-glycolate, octanethiol, decanethiol, dodecanethiol, and octadecylthiol. Preferred mercaptan chain transfer agents include 3-mercaptopropionic acid and dodecanethiol.

Suitable amines which are useful as chain transfer agents are, for example, methylamine, ethylamine, isopropylamine, n-butylamine, n-propylamine, iso-butylamine, t-butylamine, pentylamine, hexylamine, benzylamine, octylamine, decylamine, dodecylamine, and octadecylamine. A preferred amine chain transfer agent is isopropyl amine and docylamine.

Suitable alcohols which are useful as chain transfer agents are, for example, methanol, ethanol, isopropanol, n-butanol, n-propanol, iso-butanol, t-butanol, pentanol, hexanol, benzyl alcohol, octanol, decanol, dodecanol, and octadecanol. A preferred alcohol chain transfer agent is isopropanol and dodecanol.

Suitable alpha olefin sulphonates include C₈-C₁₈ alpha olefin sulphonates, such as for example Bioterge AS40, Hostapur OS liquid, and Witconate AOS.

The hydrophobically modified polymers are prepared by processes known in the art such as disclosed in U.S. Pat. Nos. 5,147,576, and 5,650,473, incorporated herein by reference. Preferably, the hydrophobically modified polymers are prepared using conventional aqueous polymerization procedures, but employing a process wherein the polymerization is carried out in the presence of a suitable cosolvent and wherein the ratio of water to cosolvent is carefully monitored so as to maintain the ratio of water to cosolvent to keep the polymer, as it forms, in a sufficiently mobile condition and to prevent unwanted homopolymerization of the hydrophobic monomer and subsequent undesired precipitation thereof.

The hydrophobically modified polymer may be dried to a powder by means known in the art such as by spray-drying, drum-drying, or freeze-drying. The polymer powder may then be combined with other granulated detergent ingredients and formed into tablets. The polymer functions both as a dispersing aid and as a soil release aid. The polymer has been found to prevent gel formation of surfactants, thus increasing the solubility rate of the tablet. The detergent ingredients that may be combined with the polymer include anionic, cationic, non-ionic, and/or amphoteric surfactants. Other detergent ingredients known in the art may be included into the formulation, and include one or more builders, co-builders, ion exchangers, alkalis, anticorrosion materials, antiredeposition materials, optical brighteners, fragrances, dyes, chelating agents, enzymes, whiteners, brighteners, antistatic agents, sudsing control agents, solvents, hydrotropes, bleaching agents, perfumes, bleach precursors, water, buffering agents, soil removal agents, soil release agents, softening agents, opacifiers, inert diluents, buffering agents, corrosion inhibitors, graying inhibitors, and stabilizers. Detergent tablets of the invention may be formulated for use in either laundry or auto-dish washing applications. The tablets are formulated for single-dose applications. Preferably the tablets are single tablets, though they may be part of a multi-tablet bundle from which a single dose may easily be broken off. The tablets can be shaped to fit into automatic dispensers found in laundry and dish washing machines. The hydrophobically modified polymer of the invention is formulated into the tablet at from 0.001 to 50 percent by weight.

The hydrophobically modified polymer may also be formulated for use in a sachet or pouch. The formulations within the sachet are non-aqueous, but may contain a minimal amount of water. The hydrophobic polymer dissolves in non-aqueous solvents typically used in sachet formation, such as polyethylene glycol, ethylene glycol and propylene glycol. The non-aqueous detergent composition within the sachet may be formulated for either laundry or auto-dish washing applications.

The hydrophobically modified polymer of the invention has been found to inhibit corrosion of aluminum. The polymer may be formulated into a solution useful for cleaning aluminum surfaces, as a car wash rinse off aid, for metal-working fluids, and for de-icing fluids for airplanes.

In addition to all of its other benefits, the hydrophobically modified polymer has been found to be useful in a rinse aid in automatic dishwasher applications. Rinse aids generally consist of a non-ionic surfactant or mixture of surfactants. These surfactants often include ethoxylated and/or propoxylated surfactants. The surfactant(s) act to reduce the surface tension of the articles being washed, thereby providing for an even drying of the articles, and a reduction in spotting. The polymer acts as a dissolution aid to aid in the dissolving of the surfactant into the rinse water.

The following non-limiting examples illustrate further aspects of the invention.

### EXAMPLE 1

Preparation of Hydrophobically Modified Polymer Containing 33.3 Mole % Acrylic Acid and 66.7 Mole % Styrene (Structure I).

An initial charge of 140 g of deionized water and 240 g of isopropyl alcohol was added to a 1 liter glass reactor fitted with a lid having inlet ports for an agitator, water cooled condenser and for the addition of monomer and initiator solutions. The reactor contents were heated to reflux (approximately 86° C.). At reflux, continuous additions of 103 g of acrylic acid, 297 g of styrene and 1 g of dodecylmercaptan (DDM), were added to the reactor concurrently with stirring over a period of 3 hours. During the same time period and for 30 additional minutes, the following initiator solutions were added to the reactor:

| | |
|---|---|
| Initiator Solution #1 | |
| t-butyl hydroperoxide | 40 g |
| Isopropyl alcohol | 20 g |
| Deionized water | 20 g |
| Initiator Solution #2 | |
| sodium formaldehyde sulphoxylate | 16 g |
| Deionized water | 80 g |

At the end of the initiator addition, a 47% aqueous sodium hydroxide solution (100 g) was added to yield a polymer solution having a final pH of approximately 7 to 8. The reaction temperature was maintained at reflux for a further 1 hour to eliminate any unreacted monomer.

After the 1 hour hold the alcohol cosolvent was removed from the polymer solution by azeotropic distillation under vacuum. During the distillation, deionized water was added to the polymer solution to maintain a reasonable polymer viscosity. The aqueous solution of the hydrophobically modified polymer was cooled to less than 30° C.

### EXAMPLE 2

Preparation of Hydrophobically Modified Polymer Containing 60 Mole % Acrylic Acid and 40 Mole % Styrene.

An initial charge of 86.4 g of deionized water, 79.2 g of isopropyl alcohol, and 0.042 grams of ferrous ammonium sulfate were added to a 1 liter glass reactor. The reactor contents were heated to reflux (approximately 84° C.).

At reflux, continuous additions of 64.5 g of acrylic acid, 62.1 g of styrene, 0.1 g of dodecylmercaptan, were added over a period of 3.5 hours. The initiator and chain transfer solutions were added at the same time as the above described monomer solution over a period of 4 hours and 3.25 hours, 5 respectively.

| | |
|---|---|
| Initiator solution | |
| Sodium persulfate | 5.72 g |
| Water | 14.0 g |
| Hydrogen peroxide 35% | 16.7 g |
| Chain transfer solution | |
| 3-mercapto propionic acid, 99.5% | 4.9 g |
| water | 21.8 g |

After adding the initiator and chain transfer solutions, the reaction temperature was maintained at about 88° C. for one hour. The alcohol cosolvent was removed from the polymer solution by azeotropic distillation under vacuum. During the distillation, a mixture of 144 g of deionized water and 64.1 g of a 50% sodium hydroxide solution was added to the polymer solution. A small amount of ANTIFOAM 1400 (0.045 g) was added to suppress any foam generated during distillation. Approximately, 190 g of a mixture of water and isopropyl alcohol were distilled off. After distillation was completed, 25 g of water was added to the reaction mixture which was cooled to obtain a yellowish amber solution.

### EXAMPLE 3

Preparation of Hydrophobically Modified Polymer Containing 49 Mole % Acrylic Acid and 51 Mole % Styrene.

An initial charge of 195.2 g of deionized water, 279.1 g of isopropyl alcohol, and 0.0949 grams of ferrous ammonium sulfate were added to a 1 liter glass reactor. The reactor contents were heated to reflux (approximately 84° C.).

At reflux, continuous additions of 121.4 g of acrylic acid, 175.5 g of styrene, were added over a period of 3.5 hours. The initiator and chain transfer solutions were added at the same time as the above described monomer solution over a period of 4 hours and 3.25 hours, respectively.

| | |
|---|---|
| Initiator solution | |
| Sodium persulfate | 12.93 g |
| Water | 31.6 g |
| Hydrogen peroxide 35% | 37.8 g |
| Chain transfer solution | |
| 3-mercapto propionic acid, 99.5% | 11.1 g |
| water | 49.3 g |

After adding the initiator and chain transfer solutions, the reaction temperature was maintained at about 88° C. for one hour. The alcohol cosolvent was removed from the polymer solution by azeotropic distillation under vacuum. During the distillation, a mixture of 325.6 g of deionized water and 134.8 g of a 50% sodium hydroxide solution was added to the polymer solution. A small amount of ANTIFOAM 1400 (0.10 g) was added to suppress any foam generated during distillation. Approximately, 375.0 g of a mixture of water and isopropyl alcohol were distilled off. After distillation was completed, 25 g of water was added to the reaction mixture which was cooled to obtain a yellowish amber solution.

### EXAMPLE 4

Preparation of Hydrophobically Modified Polymer Containing 96.1 Mole % Acrylic Acid and 3.9 Mole % Laurylmethacrylate.

An initial charge of 190 g of deionized water and 97.1 g of isopropyl alcohol were added to a 1 liter glass reactor. The reactor contents were heated to reflux (approximately 82° C.-84° C.). At reflux continuous additions of 105 g of acrylic acid, and 15.0 g of laurylmethacrylate were added to the reactor concurrently over a 3 hour period of time with stirring. Concurrently, an initiator solution containing 15.9 g of sodium persulfate and 24.0 g of water was added over a period of 4 hours.

The reaction temperature was maintained at 82° C.-85° C. for an additional hour. The alcohol cosolvent was removed from the polymer solution by azeotropic distillation under vacuum. During the half way point of the distillation (when approximately 100 g of distillate is producted), 48 g of hot water was added to the polymer solution to maintain a reasonable polymer viscosity. A small amount of ANTIFOAM 1400 (0.045 g) was added to suppress any foam that may be generated during distillation. Approximately, 200 g of a mixture of water and isopropyl alcohol was distilled off. The distillation was stopped when the isopropyl alcohol level in the reaction product was less than 0.3 weight percent.

The reaction mixture was cooled to less than 40° C. and 45 g of water and 105.8 g of a 50% NaOH was added to the reaction mixture with cooling while maintaining a temperature of less than 40° C. to prevent hydrolysis of the laurylmethacrylate. The final product was an opaque viscous liquid.

### EXAMPLE 5

Synthesis of Hydrophobically Modified Polyacrylic Acid with a C₁₂ Chain Transfer Agent.

524.8 g of water and 174 g of isopropyl alcohol were heated in a reactor to 85° C. A mixture of 374 g of acrylic acid and 49 g of n-dodecylmercaptan were added to the reactor over a period of three hours.

After addition was completed, 65.3 g of acrylic acid was added over a period of 30 minutes to the reactor. At the same time, a solution of 17.5 g of sodium persulfate in 175 g of water was added to the reactor over a period of four hours. The temperature of the reactor was maintained at 85-95° C. for one hour, after which time, 125 g of water, 51 g of a 50% NaOH solution, and 0.07 g of ANTIFOAM 1400, available from Dow Chemical Company, were added to the reactor. The reaction mixture was distilled to remove the isopropyl alcohol. Approximately 300 g of a mixture of isopropyl alcohol and water were distilled off. The reaction mixture was cooled to room temperature and 388 g of a 50% NaOH solution was added.

### EXAMPLE 6

### Acrylic Acid Grafted on to a Non-Ionic Surfactant

A polymeric compound was synthesized in the following manner: Five parts of acrylic acid, 3.0 parts of a 15 mole ethylene oxide adduct of nonyl phenol nonionic surfactant commercially available from GAF Corporation under the trade name IGEPAL CO-730 and 0.7 parts of sodium hydroxide were dissolved in sufficient water to yield a 100 part aqueous solution. The solution was stirred and heated to 60.degree. C. One part of sodium persulfate was, then, added thereto. After several minutes an exotherm was apparent with a temperature rise to 75.degree. C. Stirring was continued for 90 minutes while the temperature was maintained at 75.degree. C. The resulting solution was cooled and exhibited a clear, yellowish color and was slightly acidic.

### EXAMPLE 7

### Preparation of Copolymers Containing a Surfactant Moiety in a Hydrophilic Solvent

In a reactor provided with a stirrer 750 parts by weight deionized water and 250 parts isopropanol were heated to 82.degree. C. A monomer/initiator mixture was made containing 350 parts by weight acrylic acid, 150 parts by weight of an ester of methacrylic acid and an (C.sub.16-C.sub.18)alkoxypoly(ethyleneoxy)ethanol having about twenty ethoxy units, and 8 parts by weight methacrylic acid. Five minutes before the monomer/initiator feed began, 2 parts by weight Lupersol 11 were added to the 82.degree. C. isopropanol mixture. The monomer/initiator mixture was then metered in over 2 hours, with the reactor contents kept at 82.degree. C. Thereafter, the reactor contents were heated at 82.degree. C. for a further 30 minutes, then cooled, giving a copolymer dissolved in a water/isopropanol mixed solvent.

### EXAMPLE 8

### Dissolution of Polymers in Solvents Used in Pouches/Sachets

The polymer in Example 3 was dissolved in propylene glycol to produce a solution containing 1% polymer. The polymer in Example 3 dissolved easily. However, typical acrylate polymers such as Alcosperse 602^{ND} and acrylate-maleate copolymers such as Alcosperse 408D (available from Alco Chemical, Chattanooga, Tenn.) did not dissolve in propylene glycol.

### EXAMPLE 9

10 grams of a non-ionic surfactant which was a C₁₂₋₁₅ alcohol with 7 moles of ethoxylation such as Neodol 25-7 (available from Shell) was added to 500 grams of DI water at 20C with stirring. The surfactant formed a gel phase and took 20 minutes to dissolve. The experiment was repeated by adding a mixture of 1.5 grams of the polymer solution from Example 3 and 5 grams of Neodol 25-7. The surfactant dissolved easily and was completely soluble in 2 minutes.

### EXAMPLE 10

### Solubility of Anionic Surfactant in High Electrolyte Media

5 grams of a 60% solution of sodium lauryl ether sulfate (an anionic surfactant) was added to 500 grams of a 10% solution of sodium carbonate at 22C. The surfactant dissolved very slowly and took about 35 minutes to dissolve. The experiment was repeated by adding 1.5 grams of the polymer solution of Example 3. The surfactant dissolved in only 3 minutes in this experiment. This indicates that the polymers of this invention will help the anionic surfactants dissolve in a high electrolyte environment that is present during the course of tablet dissolution.

### EXAMPLE 11

### Example of a Tablet Formulation

Tablets are prepared as set out in the following table:

| Granulated Components | Wt % |
|---|---|
| coconut primary alkyl sulphate | 10.9 |
| coconut alcohol 3EO | 7.0 |
| coconut alcohol 6EO | 6.1 |
| zeolite A24 | 37.0 |
| soap | 4.0 |
| SCMC | 1.2 |
| fluorescer | 0.3 |
| water | 7.5 |
| PEG 1500 | 4.3 |
| protease | 1.5 |
| amylase | 0.8 |
| lipase | 0.8 |
| sodium citrate dihydrate | 15.6 |
| Polymer of Example 3 | 3.0 |

### EXAMPLE 12

### Aluminum Protection

Two pieces of aluminum foil were cut with the dimensions of 40 mm×15 mm. The strips were weighed, then placed into vials containing 10 ml of a 10% NaOH solution. One of the vials had 3% (dry weight) of the polymer of Example 3 added, and the other was the control. The strips were allowed to remain in the vials for 15 minutes, with occasional agitation. After this time, the strips were rinsed with water, then acetone (to dry them) and weighed. The amount of aluminum dissolved during the test was calculated with the following results:

| Sample | Initial Weight | Weight After Test | Percent Loss |
|---|---|---|---|
| Control | 0.0379 | 0.0115 | 69.6 |
| Ex 3 | 0.0374 | 0.0195 | 47.9 |

The data indicate that the polymer of Example 3 slows down the corrosion rate of Aluminum.

### EXAMPLE 13

### Typical Hard Surface Cleaning Formulations

| Alkaline Cleaner | |
|---|---|
| Water | 89.0 |
| Sodium tripolyphosphate | 2.0 |
| Sodium silicate | 1.9 |
| NaOH (50%) | 0.1 |
| Dipropylene glycol monomethyl ether | 5.0 |
| Octyl polyethoxyethanol, 12-13 moles EO | 1.0 |
| Polymer of example 2 | 1.0 |

### EXAMPLE 14

### Typical Automatic Dishwash Formulation

| Ingredients | Amounts |
|---|---|
| Sodium tripolyphosphate | 25.0 |
| Sodium carbonate | 25.0 |
| C12-15 linear alcohol ethoxylate | 3.0 |
| with 7 moles of EO | |
| Polymer of Example 3 | 4.0 |
| Sodium sulfate | rest |

### EXAMPLE 15

### Car Wash Rinse Off Aid Formulation

| Ingredients | wt % |
|---|---|
| Water | 80 |
| Butyldiglycol | 10 |
| Polymer of Example 2 | 10 |

### EXAMPLE 16

### Personal Care Formulation

Water repellant sunscreen

| Ingredients | Wt % |
|---|---|
| Glycerin | 5.0 |
| Polymer of Example 4 | 2.0 |
| PEG 100 stearate | 5.0 |
| Isostearyl stearate | 4.0 |
| Octyl methoxycinnamate | 7.5 |
| Butyl methoxydibenzoylmethane | 1.5 |
| Hexyl methicone | 5.0 |
| DI water | rest |

### EXAMPLE 17

### Synthesis of a Sulfonate Copolymer of 59.52 Moles Acrylic Acid, 33.87 Moles of Styrene and 6.59 Moles of Sodium Acrylamido-2-Methylpropane Sulfonate.

An initial charge of 66.1 g of deionized water, 88.2 g of isopropyl alcohol, and 0.042 grams of ferrous ammonium sulfate were added to a 1 liter glass reactor. The reactor contents were heated to reflux (approximately 84° C.).

At reflux, continuous additions of 59.1 g of acrylic acid, 47.6 g of styrene, 0.3 g of dodecylmercaptan, 27.4 g of Isopropanol and 41.6 g of 50% solution of sodium acrylamido-2-methylpropane sulfonate (AMPS from Lubrizol) were added over a period of 3.0 hours. The initiator solution was added at the same time as the above described monomer solution over a period of 3.5 hours.

| Initiator solution | |
|---|---|
| Sodium persulfate | 4.85 g |
| Water | 27.8 g |
| Hydrogen peroxide 35% | 15.9 g |

A post feed of 8.0 g of sodium persulfate in 13.3 grams of water was added over 1 hour. The alcohol cosolvent was removed from the polymer solution by azeotropic distillation under vacuum and a nitrogen purge. During the distillation, a mixture of 60.0 g of deionized water and 59.0 g of a 50% sodium hydroxide solution was added to the polymer solution. A small amount of ANTIFOAM 1400 (0.1 g) was added to suppress any foam generated during distillation. Approximately, 220 g of a mixture of water and isopropyl alcohol were distilled off. After distillation was completed, 20 g of water was added to the reaction mixture which was cooled to obtain a yellowish amber solution.

### EXAMPLE 18

### Synthesis of a Sulphonate Terminated Copolymer of Acrylic Acid (0.56 mol %) and Styrene (0.40 mol %) and Alpha Olefin Sulphonate (0.04 mol %)

An initial charge of deionized water (165 g), propan-1-ol (234 g), Bioterge AS40 (Product of Stepan 150 g) and sodium persulphate 0.5 g were heated to 85° C. and held for one hour in a 2 litre glass reactor.

A mixed monomer solution of acrylic acid (200 g) and styrene (210.7 g) was then added over a timeframe of 3 hours into the reactor.

Concurrently with the monomer solution, 2 separate initiator fragments comprising firstly tert-butyl hydroperoxide (15.2 g), propan-1-ol 15 g and water 115 g and secondly sodium formaldehyde sulphoxilate (6.1 g) and water (140 g) were fed over a timeframe of 3.25 hours.

A post feed of sodium persulphate (4.7 g) in water (35 g) was fed into the reactor over 1 hour. The reaction was then neutralized with 177.6 g of 50% aqueous sodium hydroxide.

A small amount of Antifoam 1400 (1 g) was added to the reaction to suppress foam formation during distillation. During distillation the reaction was diluted with an equal quantity by mass of water to distillate as the distillate was removed. Approximately, a 500 g mixture of water and propan-1-ol was distilled from the reaction leaving a yellow/amber solution.

### EXAMPLE 19

Examples 19 and 20 demonstrate the incorporation of an oleyl functional group into a polymer. The oleyl moiety may be in the form of a functional oleyl, eg oleyl alcohol, amine, carboxylic or alkoxylated and functionalized with alcohol, amine, carboxylic, sulphonate, sulphate, phosphate. Crodaphos N3A is a oleyl 3 mole ethoxylated phosphate.

Preparation of Copolymers Containing an Oleyl Functionality.

In a stirred reactor 500 g of deionized water is heated to 85° C. A monomer mixture of acrylic acid (300 g) and Crodaphos N3A (30 g) were fed into the reactor over a 3 hour timeframe. Initiator solutions of 27% hydrogen peroxide (32 g) in water (60 g) and sodium formaldehyde sulphoxilate (9 g) in water (80 g) were fed concurrently with the monomer over 3.25 hours. The reaction was held for 30 minutes before cooling. The product was then neutralized with 47% sodium hydroxide (260 g) and further diluted with water (120 g).

The resultant product was in the form of a clear colorless solution.

### EXAMPLE 20

### Preparation of Copolymers Containing an Oleyl Functionality

In a stirred reactor 400 g of deionized water and Crodaphos N3A (30 g) is heated to 85° C. A monomer solution of acrylic acid (300 g) was fed into the reactor over a 3 hour timeframe. Initiator solutions of 27% hydrogen peroxide (32 g) in water (60 g) and sodium formaldehyde sulphoxilate (9 g) in water (80 g) were fed concurrently with the monomer over 3.25 hours. The reaction was held for 30 minutes before cooling. The product was then neutralized with 47% sodium hydroxide (260 g) and further diluted with water (500 g).

The resultant product was in the form of a very viscous clear colorless solution.

### EXAMPLE 21

The polymer solution from Example 2 was spray dried to a fine powder.

### EXAMPLE 22

The polymer solution from Example 3 was spray dried to a fine powder.

### EXAMPLE 23

The polymer solution from Example 17 was spray dried to a fine powder.

### EXAMPLE 24

Solubility of Powdered Polymers (Non-Aqueous Form) in Ethylene Glycol and Propylene Glycol.

The powdered polymers of Examples 21, 22, and 23 were dissolved in solvents such as ethylene glycol and propylene glycol and polyethylene glycol 200 (PEG 200). These are the solvents that are typically used in sachet applications. They are also the solvents used in deicing of airplanes and in cooling fluids. The polymers minimize Aluminum corrosion in these applications.

| | Maximum | Maximum | |
|---|---|---|---|
| | solubility | solubility | Maximum |
| | in ethylene | in propylene | solubility in |
| | glycol (wt % | glycol (wt % | PEG 200 (wt % |
| | polymer based on | polymer based on | polymer based on |
| Polymer | wt of the solvent) | wt of the solvent) | wt of the solvent) |
| Example 21 | 20 | 0 | 0 |
| Example 22 | 20 | 0 | 0 |
| Example 23 | 40 | 40 | 40 |

While the invention has been described with particular reference to certain embodiments thereof, it will be understood that changes and modifications may be made by those of ordinary skill within the scope and spirit of the following claims.

What is claimed is:

1. A discrete or single-dose detergent formulation comprising a hydrophobically modified polymer comprising:
a) a hydrophilic backbone prepared from at least one monomer selected from the group consisting of:
1) an ethylenically unsaturated hydrophilic monomer selected from the group consisting of unsaturated C₁-C₆ acid, amide, ether, alcohol, aldehyde, anhydride, ketone and ester;
2) polymerizable hydrophilic cyclic monomer;
3) non-ethylenically unsaturated polymerizable hydrophilic monomer which is selected from the group consisting of glycerol and other polyhydric alcohols;
4) and combinations thereof,
wherein said hydrophilic backbone is optionally substituted with one or more amino, amine, amide, sulfonate, sulfate, phosphonate, phosphate, hydroxy, carboxyl or oxide groups; and
b) at least one hydrophobic moiety prepared from at least one hydrophobic monomer, chain transfer agent, or surfactant; said hydrophobic monomer is selected from the group consisting of a siloxane, saturated or unsaturated alkyl and alkoxy group, aryl and aryl-alkyl group, unsaturated C₈-C₁₈ alkyl, unsaturated C₈-C₁₈ alkyl with alcohol/amine or carboxylic functionality, alkyl sulfonate, aryl sulfonate, and combinations thereof; said chain transfer agent has 1 to 24 carbon atoms and is selected from the group consisting of a mercaptan, amine, alcohol, alpha olefin sulphonate, and combinations thereof; and said surfactant is an alcohol ethoxylate or an alkyl phenol ethoxylate or alkyl benzene sulfonate,
wherein said formulation is formed into pre-measured single dose portions.

2. The detergent formulation of claim 1 wherein said formulation comprises from 0.001 to 50 weight percent, based on the total weight of formulation, of said hydrophobically modified polymer.

3. The detergent formulation of claim 1 wherein said formulation is in the form of either a tablet or a sachet.

4. The detergent formulation of claim 1 further comprising at least one surfactant and/or a builder.

5. The detergent formulation of claim 1 wherein said formulation comprises a laundry detergent.

6. The detergent formulation of claim 1 wherein said formulation comprises an auto-dishwashing detergent.

7. The detergent formulation of claim 1 wherein the ethylenically unsaturated hydrophilic monomer is selected from the group consisting of acrylic acid, methacrylic acid, ethacrylic acid, alpha-chloro-acrylic acid, alpha-cyano acrylic acid, beta methyl-acrylic acid (crotonic acid), alpha-phenyl acrylic acid, beta-acryloxy propionic acid, sorbic acid, alpha-chloro sorbic acid, angelic acid, cinnamic acid, p-chloro cinnamic acid, beta-styryl acrylic acid (1-carboxy-4-phenyl butadiene-1,3), itaconic acid, maleic acid, citraconic acid, mesaconic acid, glutaconic acid, aconitic acid, fumaric acid, tricarboxy ethylene, 2-acryloxypropionic acid, 2-acrylamido-2-methyl propane sulfonic acid, vinyl sulfonic acid, vinyl phosphonic acid, sodium methallyl sulfonate, sulfonated styrene, allyloxybenzenesulfonic acid, dimethylacrylamide, dimethylaminopropylmethacrylate, diethylaminopropylmethacrylate, vinyl formamide, vinyl acetamide, polyethylene glycol esters of acrylic acid and methacrylic acid and itaconic acid, vinyl pyrrolidone, vinyl imidazole, maleic acid, maleic anhydride, and combinations thereof.

8. The detergent formulation of claim 1 wherein the hydrophobic monomer is selected from the group consisting of styrene, α-methyl styrene, 2-ethylhexyl acrylate, 2-hydroxyethyl acrylate, octylacrylate, lauryl acrylate, stearyl acrylate, behenyl acrylate, 2-ethylhexyl methacrylate, octylmethacrylate, lauryl methacrylate, stearyl methacrylate, behenyl methacrylate, 2-ethylhexyl acrylamide, octylacrylamide, lauryl acrylamide, stearyl acrylamide, behenyl acrylamide, propyl acrylate, butyl acrylate, pentyl acrylate, hexyl acrylate, 1-vinyl naphthalene, 2-vinyl naphthalene, 3-methyl styrene, 4-propyl styrene, t-butyl styrene, 4-cyclohexyl styrene, 4-dodecyl styrene, 2-ethyl-4-benzyl styrene, 4-(phenylbutyl) styrene, and combinations thereof.

9. The detergent formulation of claim 1 wherein the chain transfer agent has from 3 to 18 carbon atoms.

10. A formulation comprising a non-aqueous solution comprising a hydrophobically modified copolymer comprising:
a) a hydrophilic backbone prepared from at least one monomer selected from the group consisting of:
1) an ethylenically unsaturated hydrophilic monomer selected from the group consisting of unsaturated C₁-C₆ acid, amide, ether, alcohol, aldehyde, anhydride, ketone and ester;
2) polymerizable hydrophilic cyclic monomer;
3) non-ethylenically unsaturated polymerizable hydrophilic monomer which is selected from the group consisting of glycerol and other polyhydric alcohols;
4) and combinations thereof,
wherein said hydrophilic backbone is optionally substituted with one or more amino, amine, amide, sulfonate, sulfate, phosphonate, phosphate, hydroxy, carboxyl or oxide groups; and
b) at least one hydrophobic moiety prepared from at least one hydrophobic monomer, chain transfer agent, or surfactant; said hydrophobic monomer is selected from the group consisting of a siloxane, saturated or unsaturated alkyl and alkoxygroup, aryl and aryl-alkyl group, alkyl sulfonate, aryl sulfonate, unsaturated C₈-C₁₈ alkyl, unsaturated C₈-C₁₈ alkyl and alcohol/amine or carboxylic functionality, and combinations thereof; said chain transfer agent has 1 to 24 carbon atoms and is selected from the group consisting of a mercaptan, amine, alcohol, alpha olefin sulphonate, and combinations thereof; and said surfactant is an alcohol ethoxylate or an alkyl phenol ethoxylate or alkyl benzene sulfonate.

11. The formulation of claim 10, further comprising ethylene glycol, polyethylene glycol or propylene glycol.

12. A method for treating aluminum comprising contacting at least one surface of an aluminum object with a formulation comprising a hydrophobically modified copolymer comprising:
a) a hydrophilic backbone prepared from at least one monomer selected from the group consisting of:
1) an ethylenically unsaturated hydrophilic monomer selected from the group consisting of unsaturated C₁-C₆ acid, amide, ether, alcohol, aldehyde, anhydride, ketone and ester;
2) polymerizable hydrophilic cyclic monomer;
3) non-ethylenically unsaturated polymerizable hydrophilic monomer which is selected from the group consisting of glycerol and other polyhydric alcohols;
4) and combinations thereof,
wherein said hydrophilic backbone is optionally substituted with one or more amino, amine, amide, sulfonate, sulfate, phosphonate, phosphate, hydroxy, carboxyl or oxide groups;
b) at least one hydrophobic moiety prepared from at least one hydrophobic monomer, chain transfer agent, or surfactant; said hydrophobic monomer is selected from the group consisting of a siloxane, saturated or unsaturated alkyl and alkoxy group, aryl and aryl-alkyl group, alkyl sulfonate, aryl sulfonate, and combinations thereof; said chain transfer agent has 1 to 24 carbon atoms and is selected from the group consisting of a mercaptan, amine, alcohol, alpha olefin sulphonate, and combinations thereof; and said surfactant is an alcohol ethoxylate or an alkyl phenol ethoxylate or alkyl benzene sulfonate,

13. The method of claim 12 wherein said treatment comprises de-icing.

14. The method of claim 12 wherein said treatment comprises cleaning.

15. The method of claim 12 wherein said solution comprises a metal-working fluid.

16. A rinse aid composition comprising a hydrophobically modified polymer comprising:
a) a hydrophilic backbone prepared from at least one monomer selected from the group consisting of:
1) an ethylenically unsaturated hydrophilic monomer selected from the group consisting of unsaturated C₁-C₆ acid, amide, ether, alcohol, aldehyde, anhydride, ketone and ester;
2) polymerizable hydrophilic cyclic monomer;
3) non-ethylenically unsaturated polymerizable hydrophilic monomer which is selected from the group consisting of glycerol and other polyhydric alcohols;
4) and combinations thereof,
wherein said hydrophilic backbone is optionally substituted with one or more amino, amine, amide, sulfonate, sulfate, phosphonate, phosphate, hydroxy, carboxyl or oxide groups; and
b) at least one hydrophobic moiety prepared from at least one hydrophobic monomer, chain transfer agent, or surfactant; said hydrophobic monomer is selected from the group consisting of a siloxane, saturated or unsaturated alkyl and alkoxy group, aryl and aryl-alkyl group, unsaturated C₈-C₁₈ alkyl, unsaturated C₈-C₁₈ alkyl with alcohol/amine or carboxylic functionality, alkyl sulfonate, aryl sulfonate, and combinations thereof; said chain transfer agent has 1 to 24 carbon atoms and is selected from the group consisting of a mercaptan, amine, alcohol, alpha olefin sulphonate, and combinations thereof; and said surfactant is an alcohol ethoxylate or an alkyl phenol ethoxylate or alkyl benzene sulfonate,
wherein said composition is used as a rinse aid in the rinse cycle of an automatic dishwasher.

17. The composition of claim 16 wherein said composition further comprises at least one non-ionic surfactant.
